(19) United States
(12) Patent Application Publication
(10) Pub. No.: US 2026/0187165 A1
(43) Pub. Date: Jul. 2, 2026

(54) LOCAL DIGITAL COMPONENT STORAGE

(71) Applicant: GOOGLE LLC, Mountain View, CA (US)

(72) Inventors: Jacob Mark Hallberg, Sunnyvale, CA (US); Rishav Anand, Mountain View, CA (US)

(21) Appl. No.: 18/844,859

(22) PCT Filed: Apr. 5, 2023
(86) PCT No.: PCT/US2023/017578

§ 371 Date: Sep. 6, 2024

(51) Int. Cl. G06F 3/06

(52) U.S. Cl. CPC G06F 16/9535; G06Q 10/40; H04L 67/306

(57) ABSTRACT

Methods, systems, and apparatus, including computer programs encoded on a computer storage medium, for digital component storage are described. In one aspect, a method includes receiving, by a client device and from one or more content platforms, a plurality of digital components. Each of the digital components corresponds to user data associated with at least a first application executing on the client device. The client device stores the plurality of the digital components in a repository, and determines a score for each digital component stored in the repository based on a number of times the digital component has been received. The client device receives a request for digital content for presentation in a second application that is different than the first application. The client device selects one of the p digital components based on the scores, and provides the selected digital component for presentation in the second application.

### TECHNICAL FIELD

This specification is related to data processing, data privacy, and data security.

### BACKGROUND

Data security and user privacy are vital in systems and devices connected to public networks, such as the Internet. Concerns about user privacy have led many developers to change the ways in which user data is handled. For example, some browser developers are planning to deprecate the use of third-party cookies.

### SUMMARY

A repository on a user device can store a set of digital content in order to increase efficiency and privacy. Digital content serving (for example, providing digital content to applications on a user device) can include digital content targeting by selecting a subset of digital content at a content server and selecting targeted digital content on the user device. Digital content subselection can bring a smaller set of digital content to the user device for on-device digital content selection. Large content servers can store more digital content than the on-device digital content selection and auction process can support. All of the digital content in an online repository associated with a content server cannot be downloaded to the user device due to storage and processing constraints.

On-device digital content repository building can include building models that can subselect meaningful digital content from an off-device digital content repository with non-sensitive data that is able to leave the device. These models may be limited from selecting digital content based on third party signals (for example, user data associated with another application). The selection process by these models may not be as accurate as an approach that has access to all signals (for example, third party signals).

The user device may make a request to the content servers in order to fetch digital content. For example, a website accessed on a user device can have organic content and a tag (for example, JavaScript tag, html tag). The website can include a rectangular box (for example, an iframe) to which digital content can be added. A request can be sent to content servers including an identifier for the website (for example, a URL). The content server can retrieve digital content from an associated inventory based on the request, score the digital content using digital signals, and send digital content back to the user device to be rendered on the website for the user.

The device digital content repository allows digital content scoring and retrieval to take place on the device. On-device digital content serving may not work with the total inventory of digital content that servers have. User devices may lack the computing power of content servers, which perform the digital content retrieval and scoring on large quantities of digital content. For example, content servers can perform indexing, retrieval, fetching, scoring, and/or auctioning of digital content. On-device digital content serving may work on a smaller subset of the inventory of digital content from the content servers.

Available user data (for example, interests) can be used to improve the selection of the subset of digital content. In some implementations, a subset of digital content can be randomly selected for the on-device repository, and digital content can be served from the repository. However, selecting a subset of the digital content inventory using user data can increase the effectiveness for the digital content providers. For example, user data (for example, interest or disinterest in gaming, music, and/or cooking) can be used to avoid randomly selected, less relevant digital content (for example, digital content related to cooking) and efficiently use storage space on the device.

The subset of digital content can be retrieved synchronously or asynchronously. Synchronous digital content retrieval can occur at the time of the digital content request while an application is active. Asynchronous digital content retrieval can occur during safe times to download the digital content. For example, asynchronous digital content retrieval can occur while the application is not active, while the device is charging, and/or while the device is connected to an unmetered connection.

In general, one innovative aspect of the subject matter described in this specification can be embodied in methods including the operations of receiving, by a client device and from one or more content platforms, a plurality of digital components, wherein each of the digital components corresponds to user data associated with at least a first application executing on the client device; storing, by the client device, the plurality of the digital components in a repository on the client device; determining, by the client device, a score for each digital component of the plurality of the digital components stored in the repository, wherein the determining is based on a number of times the digital component has been received; receiving, by the client device, a request for digital content for presentation in a second application executing on the client device, wherein the second application is different than the first application; selecting, by the client device, one of the plurality of the digital components based on the scores of the plurality of digital components; and providing, by the client device, the selected one of the digital components for presentation in the second application. Other implementations of this aspect include corresponding apparatus, systems, and computer programs, configured to perform the aspects of the methods, encoded on computer storage devices.

In general, one innovative aspect of the subject matter described in this specification can be embodied in methods including the operations of receiving, by a server and from a client device, a request for digital components for presentation by the client device, wherein the request for the digital components include user data associated with at least a first application executing on the client device; and in response to receiving the request for the digital component, transmitting, by the multi-platform server and to the client device, a plurality of digital components, wherein each of the digital components corresponds to the user data.

These and other implementations can each optionally include one or more of the following features. In some aspects, the plurality of the digital components are received in response to a request from the first application. Methods can include the operations of receiving a second plurality of the digital components in response to a request from a third application on the client device.

In some aspects, wherein scoring each digital component of the plurality of the digital components stored in the repository comprises scoring a first digital component included in both the first subset of the plurality of the digital components and the second subset of the plurality of the digital components higher than a second digital component not include in both the first subset of the plurality of the digital components and the second subset of the plurality of the digital components.

In some aspects, methods can include the operations of determining that a number of digital components in the repository on the client device exceeds a predetermined threshold value; and in response to determining that the number of digital components in the repository on the client device exceeds the predetermined threshold value, removing a digital component with a lowest score from the repository on the client device.

In some aspects, the user data associated with at least the first application comprises at least one of first party data, contextual data, or privacy safe data.

In some aspects, the user data associated with at least the first application comprises a sequence of actions which a user performed with the second application.

In some aspects, the plurality of the digital components are received in response to transmitting a request that includes the user data associated with at least the first application.

In some aspects, the request for the digital content for presentation in the second application comprises the user data; and the one of the plurality of the digital components is selected based on the user data.

In some aspects, methods can include the operations of determining a second score for each digital component of the plurality of the digital components stored in the repository, wherein the second score is determined based on at least one of first party signals, third party signals, or contextual signals; and selecting the one of the plurality of the digital components based on the scores and second scores of the plurality of digital components.

Particular embodiments of the subject matter described in this specification can be implemented so as to realize one or more of the following advantages. Storing and fetching content from a repository on the client device reduces the amount of data retrieved from content servers, thereby preventing a degradation of the user experience through overuse of resources of the client device. For example, content request can be faster, battery consumption can be reduced, network consumption can be reduced, and response times can be faster when the user interacts with displayed content. User privacy can be increased because private third party data does not need to be shared with content servers.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a server distributes digital components to client devices in a privacy preserving manner.

FIG. 2 is a block diagram of an example environment in which a client device selects digital components.

FIG. 3 is a block diagram of an example environment in which a server distributes digital components to a client device in a privacy preserving manner.

FIG. 4 is a block diagram of an example environment in which a client device selects digital components.

FIG. 5 is a diagram of an example embedding space.

FIG. 6 is a diagram of an example environment including a two tower model.

FIG. 7 is a diagram of an example environment illustrating relationships between applications.

FIG. 8 is a diagram of an example embedding space.

FIG. 9 is a flow diagram of an example process for selecting and providing a digital component for display at a client device in a privacy preserving manner.

FIG. 10 is a block diagram of an example computer system.

Like reference numbers and designations in the various drawings indicate like elements.

### DETAILED DESCRIPTION

In general, this document describes systems and techniques for selecting digital content for storage in an on-device repository. The on-device repository can protect user privacy and confidential data of content providers while efficiently using storage space on the user device. Digital content can be added to the repository based on signals from applications on the device. The applications can request digital content based on user information accessible to the application in order to receive relevant digital content.

For example, applications have a first party relationship with the user where the application knows how the user has interacted with the application. If the application has sufficient permissions, the application can send user information to the content server. The digital content can be requested asynchronously of the latency critical path. For example, digital content can be requested while the application is not displayed on the device and/or before a user opens the application and a content request is made.

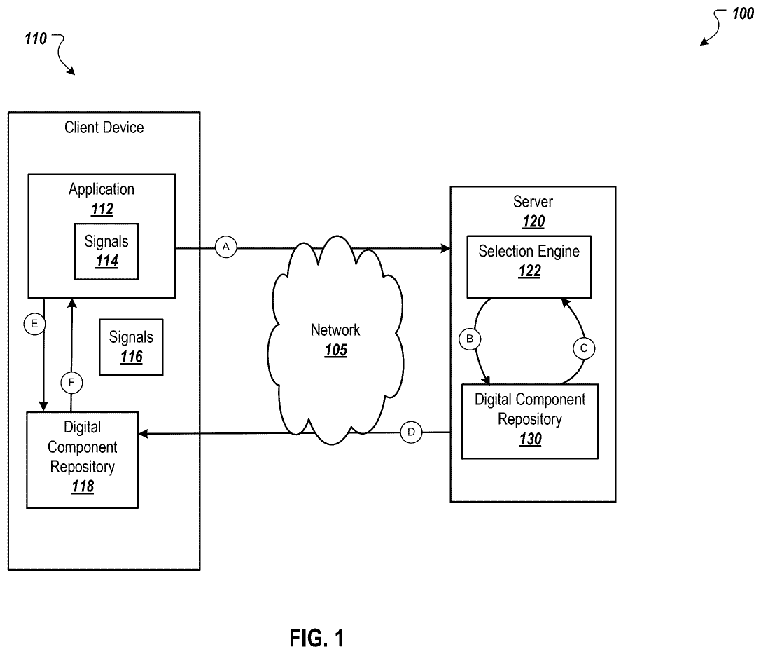

FIG. 1 is a block diagram of an example environment 100 in which a server 120 distributes digital components to a client device 110 in a privacy preserving manner. The environment 100 includes a data communication network 105, such as a local area network (LAN), a wide area network (WAN), the Internet, a mobile network, or a combination thereof. The data communication network 105 connects one or more client devices 110 to the server 120. The server 120 can include multiple computing devices (e.g., a cloud environment). The server 120 can include digital component providers, supply side platforms (SSPs) and/or demand side platforms (DSPs). The network 105 can connect the various content platforms to one another.

A client device 110 is an electronic device that is capable of communicating over the network 105. Example client devices 110 include personal computers, server computers, mobile communication devices, e.g., smart phones and/or tablet computers, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including a wearable device (e.g., watch or glasses), a smart phone, a speaker device, a tablet device, or another hardware device. A client device can also include a digital media device, e.g., a streaming device that plugs into a television or other display to stream videos to the television, a gaming system, or a virtual reality system.

A client device 110 can include an application 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, or other application content, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

An electronic resource is also referred to herein as a resource for brevity. For the purposes of this document, a resource can refer to a web page, application page, application content presented by a native application, electronic document, audio stream, video stream, or other appropriate type of electronic resource with which a digital component can be presented.

As used throughout this document, the term “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource that includes a digital component slot, the application 112 generates a digital component request that requests a digital component for presentation in the digital component slot. In some implementations, the digital component slot and/or the resource can include code (e.g., scripts) that cause the application 112 to request a digital component from the server 120.

The client device 110 can use several signals for serving digit components through application 112. The signals can include first party signals, third party signals, contextual signals, and privacy safe signals. The client device 110 can include signals 114 specific to the application 112 (for example, how the user interacts with the application 112), and signals 116 that include cross application data. The signals 114 can include first party signals and contextual signals.

First party signals can include data collected by an application based on how a user interacted with the application. First party signals can be restricted to the application that collected the data. For example, when a user opens a first application, the first application has access to the actions the user performs and the content that is presented to the user. The first party signals can include a sequence of actions that the user performs. For example, the sequence of actions can include clicking on a link on a first page to request a second page, and clicking on a link on the second page. The first party signals can include information about how different users engaged with a current user of the application. The first party signals can include other applications that the user interacted with through the first application. The first party signals can include interactions between an application and content servers. For example, the first party signals can be provided to the content server when the application requests content when the content server does not have access to the first party signals. The first party signal can have historical dimensions. For example, an application can store interaction data for a previous period of time (for example, the last seven days, fourteen days, year) using the first party identifiers.

Contextual signals can include an action that a user is performing at a certain moment. Contextual signals can be associated with a content provider. For example, contextual signals can include content that a user is currently viewing in an application. The contextual signals can describe the environment in which a selected digital component will be presented. The contextual signals can include, for example, coarse location information indicating a general location of the client device 110, a resource (e.g., website or native application) with which the selected digital component will be presented, a spoken language setting of the application 112 or client device 110, the number of digital component slots in which digital components will be presented with the resource, the types of digital component slots, and other appropriate contextual information.

The signals 116 can include privacy safe signals and third party signals. Privacy safe signals can include any data that may leave the device in some form. In some examples, a privacy signal can include private user signals with noise applied to anonymize the user associated with the data. Privacy safe signals can include cross publisher or per device data that is exposable to a content server in some form. Certain cross site or cross add information, even though sensitive, can be rendered safe by adding some noise to it. The noise can include differentially private noise. Adding noise can increase an uncertainty of which actions the user performed so that the user's actual actions have increased privacy. For example, a privacy safe signal can indicate that a user accessed a certain application. However, the noise in the signal introduces an uncertainty that the user might not have actually accessed the certain application.

Third party signals can include data that is collected across different applications. For example, third party signals can include a sequence of actions performed with different applications. The sequence of actions can include interactions with a first application, a second application, a third application, then the first application again. Third party signals can include cross application information that is considered privacy sensitive (for example, user sensitive data) because there is an expectation of privacy that a content server should not know the user interacts with different applications.

The third party signals can include, for example, data identifying user groups that include the user as a member. The user groups can include interest-based groups. Each interest-based group can include a topic of interest and a set of members identified (e.g., determined or predicted) to be interested in the topic. The user groups can also include, for example, groups of users that performed particular actions using electronic resources (e.g., websites or native applications) of publishers. For example, a user group can include users that visited a website, users that requested more information about an item, interacted with (e.g., selected) a particular digital component and/or added an item to a virtual cart to potentially acquire the item. The user data for a user can also include user profile data and/or attributes of the user.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user or others (e.g., third parties).

An example process for selecting and providing a digital component for presentation at a client device 110 is illustrated in stages A-F of FIG. 1, which shows a flow of data between the components of the environment 100.

In stage A, the application 112 running on the client device 110 sends a digital component request to the server 120. As described above, the application 112 can send a digital component request to request a digital component for presentation in a digital component slot of a resource being presented by the application 112. In some implementations, the digital component slot and/or the resource can include code (e.g., scripts) that cause the application 112 to request a digital component from the server 120. A digital component request sent by a client device 110 can include first party signals, contextual signals, and the privacy safe signals. The digital component request can be sent asynchronously to a request for content from a user. For example, the application 112 can request content before the user views content through the application. The digital component request can be sent during a period where the client device 110 is charged and/or connected to an unmetered connection.

The server 120 can be implemented using one or more server computers (or other appropriate computing devices) that may be distributed across multiple locations. In general, the server 120 receives requests for digital components from client devices 110, selects digital components from the digital component repository 130 based on data included in the requests, and sends the selected digital components to the client devices 110.

As described in more detail below, the server 120 can select a digital component from a set of digital components stored in a digital component repository 130 and/or a set of digital components received from an SSP. The digital component repository 130 stores digital components received from content platforms (e.g., from SSPs and/or DSPs) and additional data (e.g., metadata) for each digital component. The metadata for a digital component can include, for example, distribution criteria that defines the situations in which the digital component is eligible to be provided to a client device 110 in response to a digital component request received from the client device 110 and/or a selection parameter that indicates an amount that will be provided to the publisher if the digital component is displayed with a resource of the publisher and/or interacted with by a user when presented. For example, the distribution criteria for a digital component can include location information indicating geographic locations in which that digital component is eligible to be presented, user group membership data identifying user groups to which the digital component is eligible to be presented, resource data identifying resources with which the electronic resource is eligible to be presented, and/or other appropriate distribution criteria. The distribution criteria can also include negative criteria, e.g., criteria indicating situations in which the digital component is not eligible (e.g., with particular resources or in particular locations). Other data that can be used to select a digital component can also be stored in the digital component repository with a reference (e.g., a link or as metadata) to its digital component.

An SSP is a technology platform implemented in hardware and/or software that automates the process of obtaining digital components for the resources. Publishers of resources can use an SSP to manage the process of obtaining digital components for digital component slots of its resources. Each publisher can have a corresponding SSP or multiple SSPs. Some publishers may use the same SSP.

A DSP is a technology platform implemented in hardware and/or software that automates the process of distributing digital components for presentation with the resources and/or applications. A DSP can interact with multiple supply-side platforms SSPs on behalf of digital component providers to provide digital components for presentation with the resources of multiple different publishers. Digital component providers can create (or otherwise publish) digital components that are presented in digital component slots of publisher's resources.

In stage B, the server 120 queries the digital component repository 130 for a set of user-based digital components that are selected based on the user data of the digital component request. For example, the server 120 can submit a query that defines, as conditions of the query, the user data of the digital component request. The user data can include first party signals, contextual signals, and the privacy safe signals from the request received from the application 112. In some implementations, the query can also include context-based conditions. For example, a query can request retrieval of digital components that include, as distribution criteria, a particular user group and/or a particular geographic location.

In stage C, the server 120 receives a set of user-based digital components from the digital component repository 130 and a selection parameter for each user-based digital components. The set of user-based digital components can include those having distribution criteria that matches the conditions of the query.

A selection engine 122 of the server 120 selects digital components to provide to the application 112 for presentation in the digital component slot. For example, the selection engine 122 can select a digital component from the set of context-based digital components and the set of user-based digital components. The selection engine 122 can select the digital components from the two sets based on the selection parameter for each digital component in the two sets. For example, the selection engine 122 can select a certain number of digital components having the highest selection parameters based on the signals available to the selection engine 122.

In some implementations, the selection engine 122 can filter digital components and/or selection parameters based on publisher controls specified by the publisher of the resource being presented by the application 112. In a particular example, a publisher of a web page about a particular event may define, as a publisher control, that digital components related to another event may not be presented with this web page. The selection engine 122 can filter based on rules or other data provided by the publisher.

In stage D, the server 120 provides the selected digital components to the client device 110. The client device 110 stores digital components received from the server 120 in the digital component repository 118. The digital component repository 118 can store digital components received from multiple content platforms (e.g., digital components received in response to requests from different applications on the client device 110.) For example, when the selection engine 122 selects a digital component, the server 120 can transmit the digital component to the client device 110. In some examples, the selection engine 122 can forward selection values received from an SSP to the client device 110. The client device 110 can add the digital components to the digital component repository 118.

In stage E, the application 112 can query the digital component repository 118 for a digital component for presentation in a digital component slot of a resource being presented by the application 112. In some implementations, the query can include signals 114. Although shown after stages A to D, the application 112 can query the digital component repository 118 in parallel with one or more of stages A to D to reduce the latency in selecting and providing a digital component.

In stage F, the application 112 receives a digital component. The digital component can be selected based on the signals 114 and 116. In some implementations, the digital component can be selected based on a number of times each digital component was provided to the client device 110 in response to a request to a content server. For example, a given digital component can be received at the client device multiple times (e.g., in response to requests from different application on the client device 110). A score can be assigned to the given digital component based on a number of times the given digital component was received. The client device 110 can select a digital component based on scores for each digital component stored in the digital component repository 118. In some implementations, the digital component can be selected based a combination of the number of times each digital component was received and at least one of signals 114 or 116. For example, the score for each digital component, signals 114, and signals 116 can be input to a trained model that outputs the selected digital component. The client device 110 can then present the digital component with the resource being presented by the application 112.

Generally, better digital components that are more relevant (e.g., more targeted at the particular user, more contextually similar to the application) will be selected by using more of the data signals available. That is, more data about the particular request can result in more informed digital component selection. However, not all data sources can be used while preserving privacy with on-device content selection. Performance can be improved while preserving privacy by using first party, contextual, and privacy safe data. This preserves user privacy and data security, especially when compared to techniques that employ third party cookies to send user data across the Internet.

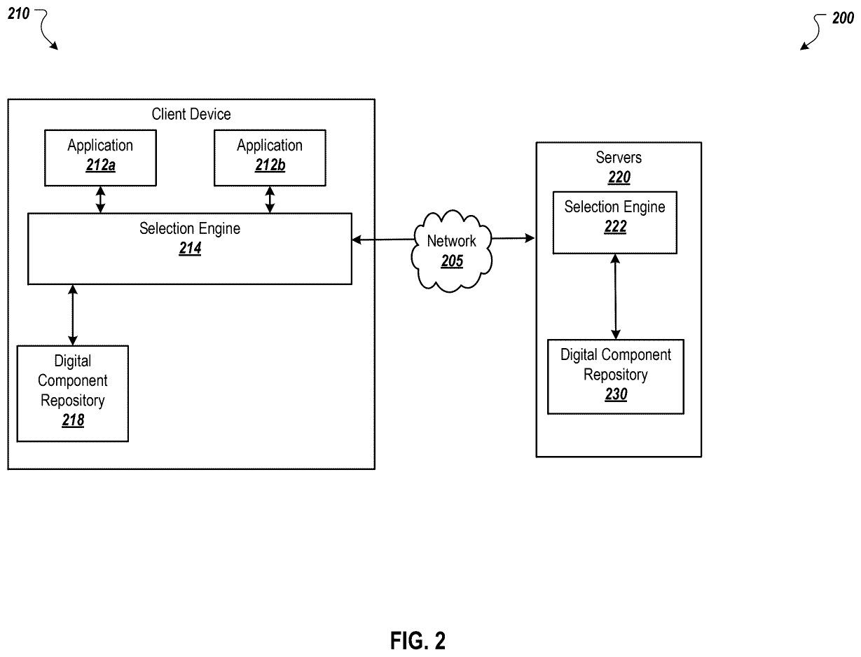

FIG. 2 is a block diagram of an example environment 200 in which a client device 210 selects digital components. The environment 200 includes a client device 210 and servers 220, for example, multi-platform server(s). More than one client device can be included in the environment 200. The servers 220, for example, can be similar to the server 120 (shown in FIG. 1). The example environment 200 includes data communication network(s) 205 (e.g., similar to data communication network 105, shown in FIG. 1) that connects client device 210 (for example, similar to client devices 110, also shown in FIG. 1) to the servers 220.

The client device 210 includes selection engine 214 and digital component repository 218 (for example, similar to digital component repository 118, shown in FIG. 1). The selection engine 214 can receive requests for digital components from the applications 212a and 212b. The requests can include first party signals and contextual signals. The selection engine 214 can determine privacy safe signals based on the data received from the applications 212a and 212b. The selection engine 214 can send a central request to the digital components from the servers 220 using the privacy safe signals. The central request can include a request for digital components for multiple applications on the client device 210.

The use of privacy safe signals can avoid sharing private third party data with the servers 220. For example, cross application data, such as a number of times the user has opened applications 212a and 212b, may be kept on the client device 210. Privacy safe signals also avoid the need for the selection engine 214 to share first party and contextual data received from different applications, as this data would become third party cross application data when shared with the servers 220. A selection engine 222 of the server 220 can select a set of digital components from the digital component repository 230 using the privacy safe signals.

The client device 210 can receive digital components from the servers 220 and store the digital components in the digital component repository 218. The selection engine 210 can determine digital components from the digital component repository 218 for presentation in applications 212a and 212b based on the first party signals and contextual signals received from the applications, as well as third party signals and privacy safe signals.

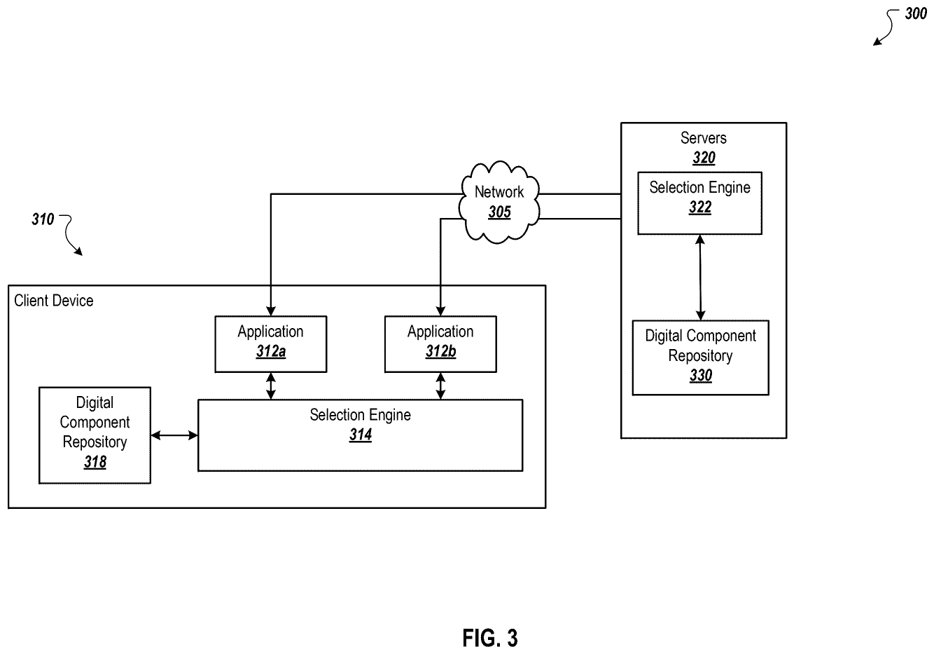

FIG. 3 is a block diagram of an example environment 300 in which a server 320 distributes digital components to a client device 310 in a privacy preserving manner. The environment 300 includes a client device 310 and servers 320, for example, multi-platform server(s). The servers 320, for example, can be similar to the server 120 (shown in FIG. 1). The example environment 300 includes data communication network(s) 305 (e.g., similar to data communication network 105, shown in FIG. 1) that connects client device 310 (for example, similar to client devices 110, also shown in FIG. 1) to the servers 320.

The client device 310 includes applications 312a and 312b, selection engine 314 and digital component repository 318. Content presented on applications 312a and 312b can include personalized signals. Presented content is based on the content with which the user interacted. A user's first party interaction with an application and the contextual content shown within that application can be considered personalized signals. Each application on the client device 310 can use the signals available to it to subselect content on a per application basis, asynchronous to the content request.

Content subselected by each application can be stored on the digital component repository 318 for providing digital components across multiple applications. The digital component repository 318 can include a centralized repository that acts as a cache on the client device 310. The collection of digital components related to each application allows a personalized ad repository to be created without leaking third party information. The digital component repository 318 can have a fixed memory and can be updated so the data is not stale. For example, the digital component repository 318 can be updated when digital components are received from the server 320 based on requests from the client device 310. The selection engine 314 can include a scoring system to keep the highest ranked content in the digital component repository 318 and remove the lowest ranked content when the digital component repository 318 is full.

The applications 312a and 312b can request content from the servers 320 using first party signals, contextual signals, and privacy safe signals. The requests can be asynchronous to the latency critical path. For example, the applications 312a and 312b can request content before the user views content through the applications. Each application on the client device 310 can request content at different time intervals. As a result, the content can be retrieved without interfering with the use of the client device 310 (e.g., the retrieval process only uses a small portion of the processing power, memory, and network bandwidth). A selection engine 322 of the server 320 can select digital components from a digital component repository 330 using the signals included in the requests from the applications. Digital components received by the applications 312a and 312b can be used to update the digital component repository 318. The content which each application receives the servers 320 can be stored in a central repository.

The quality of the content from digital component repository 318 can be more relevant (e.g., more targeted at the particular user, more contextually similar to the application) than the content from the servers 320 because the selection engine 314 can access cross domain scoring information. Content subselection can result in an on-device repository that includes content that is based on the user interactions across all applications. As each applications is responsible for subselection of content, each application informs the servers 320 of all of the signals the application has available including any personalized signals that the application has collected that otherwise would be deemed sensitive information when used in a cross applications manner.

The selection engine 314 can include a scoring mechanism. For example, when a request is made to the servers 320 from application 312a, the servers can recommend a first group of digital components, a second group of digital components, and a third group of digital components. When application 312b makes a request to the server at some other time, the servers 320 can use the first party information from application 312b to select the first group of digital components, a fourth group of digital components, and a fifth group of digital components. All of the groups of digital components can be added to the digital component repository 318. The first group of digital components can be ranked higher and have a higher priority for retention because the first group of digital components was received by both applications. In some examples, a third application on the client device 310 can receive the first group of digital components, the third group of digital components, and the fifth group of digital components. The first group of digital components can be ranked the highest because it was received three times. The third and fifth groups of digital components can be ranked higher than the second and fourth groups of digital components because the third and fifth groups of digital components were received twice and the second and fourth groups of digital components were received once.

The digital component repository 318 can remove digital components after a threshold is reached. For example, the threshold can be based on a storage space allocated for the repository and/or a number of digital components to store on the client device. The digital components with the lowest ranking can be discarded.

The servers 320 can determine a number of digital components to send to the client device 310 based on the number of digital components the digital component repository 318 can store. The number of digital components to be downloaded can be calculated, for example, as the number of digital components that the device can store divided by the number of applications that show digital components for the servers 320 over a time period of time. The number of digital components over the time period can be calculated using application Specific behaviors. For example, application specific behaviors may include an indication that users who visit application 312a generally do not visit application 312b. In some examples, users who visit application 312a generally only visit application 312a and another given application.

In some implementations, the content servers 320 can maintain a set of a number of digital components matching a number of digital components that can be stored in the digital component repository 318. The content servers 320 can provide an embedding that represents the digital components that are being fetched. After being fetched, the content servers 320 can use on-device models that have all device signals to produce an embedding on the device 310. For example, the embedding can be determined by using a multi tower approach. The selection engine 314 can include a model that can perform a dot product and cutoff of a top number of digital components against the produced embedding (for example, including all on-device signals) and the embedding associated with the candidate digital components. The cutoff number of digital components can be tuned for nearest neighbors to match the number of digital components that can be stored in the digital component repository 318 so that the device 310 never has more than that number of digital components from a server at a given time.

The servers 320 receive requests from different applications at different times, and as a result, do not have any understanding of the cross domain across applications visitation of the users. This increases privacy because the server is not aware of the different applications on the user device and how the user has interacted with the applications. First party information from only one application is provided to the server at a time. Each application can request content asynchronously and during the offload time outside of latency critical path of serving content to the user.

The selection engine 314 can select content on the device using cross applications activity and a scoring system. A more efficient system of content can be created on-device for future serving while preserving privacy. Once the digital components are on the device, then when a request is made (for example, when the user accesses an application), the selection engine 314 can select a highest ranked digital component from the digital component repository 318. As the user interacts with the applications on the client device, the first party information can change and each application can asynchronously continue downloading content. The digital component repository 318 can be updated as new content is downloaded. As user behavior changes over time, the digital component repository 318 can also change and be more suited to that user. The updated ranking of the content in the repository can be done entirely on the user device.

In some implementations, a content provider can request that its content not be shown on certain pages or applications. For example, content provided by the servers 320 can include information that the content cannot be presented with egregious or offensive content. The selection engine 314 can check condition restrictions for all of the content in the digital component repository 318 when selecting digital components. For example, if an application with egregious or offensive content requests a digital component, and the top ranked digital component is restricted from being displayed with egregious or offensive content, a highest ranked digital component without such a restriction can be provided to the application.

In some implementations, the selection engine 314 can include a trained model that selects digital components based on quality. For example, the available signals can be input into the model to determine the digital component to provide to an application. In some implementations, a quality score can be combined with a number of times the content is received to select a digital component.

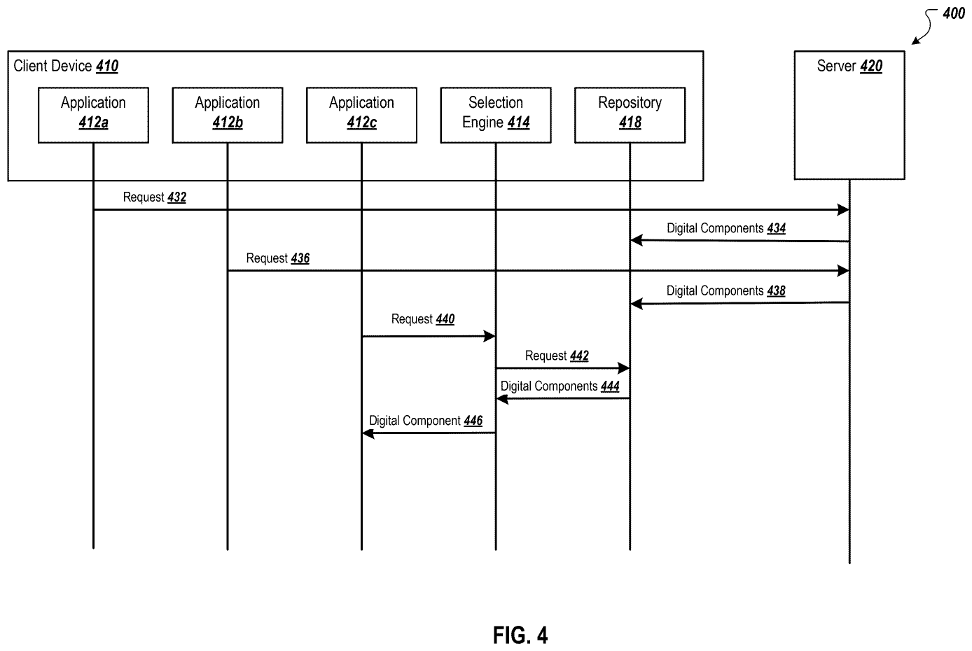

FIG. 4 is a block diagram of an example environment 400 in which a client device 410 selects digital components. The environment 400 includes a client device 410 and server 420, for example, multi-platform server(s). The server 420, for example, can be similar to the server 120 (shown in FIG. 1).

The application 412a running on the client device 410 sends request 432 to the server 420. For example, the application 412a can have access to user signals that are extremely useful for content subselection. A single user on a device may have visited an article about a football team and an article on how certain supplements help with health within the application 412a. These signals would otherwise contain sensitive information when joined across multiple applications with a shared ID. However, when not joined, these signals can be sent to the server 420 to improve content subselection while maintaining user privacy.

The server 420 can respond to the request 432 with digital components 434. For example, the server 420 can select the digital components 434 using signals included in the request 432. For example, the signals can include first party signals, contextual signals, and privacy safe signals. The server 420 can rank digital components using the received signals in order to select content driven digital components.

The repository 418 can be updated with the digital components 434. The repository 418 of personalized digital components can be used in conjunction with other privacy centric approaches for selecting digital components. For example, the repository can be used with Batch Private Information Retrieval, Private Nearest Neighbor, and/or matching in Private Compute Backend (Trusted Server—OAK). The client device 410 can use all available user data to determine the final ranking of digital components using on-device modeling.

The application 412b running on the client device 410 sends request 436 to the server 420. The request 436 can include signals relating to how the user interacted with the application 412b. The server 420 can respond to the request 436 with digital components 438. For example, the server 420 can select the digital components 436 using signals included in the request 436. The repository 418 can be updated with the digital components 438.

The application 412c running on the client device 410 sends request 440 to the selection engine 414. The selection engine 414 can determine a highest ranked digital component, and send request 442 to the repository 418 for the digital component. The selection engine 414 can receive digital components 444. The selection engine 414 can send the highest ranked digital component 446 to the application 412c.

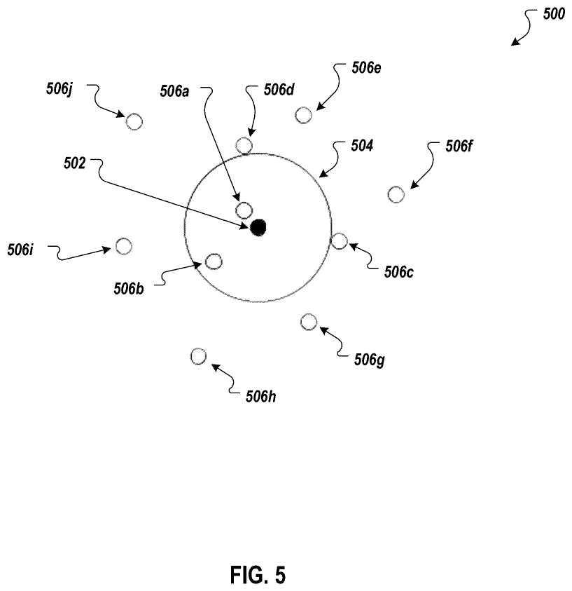

FIG. 5 is a diagram of an example embedding space 500. The embedding space 500 includes query feature embedding 502, a number of nearest neighbors 504, and candidate digital component embeddings 506a-j. Digital component selection can be formulated as a multidimensional embedding space optimization problem. The query feature embedding 502 can include the available types of input signals (for example, user, contextual, first party) embedded into a representational embedding space (for example, a higher dimensional space). An encoding mechanism (for example, a non-linear transformation) can be used to embed the input signals into the representational embedding space. For example, the encoding mechanism can transform arbitrary signals into an embedding space that is meaningful for models and subsequent usage (for example, dot product similarity, nearest neighbor). Digital components can be embedded into this embedding space as the candidate digital component embeddings 506a-j. A model can optimize the weights of the transformation to an embedding over some objective function (for example, maximizing conversions, maximizing click through rate).

During digital component serving, a dot product of embeddings can be performed to score each of the candidate digital component embeddings 506a-j, and the candidate digital component embeddings 506a and 506b included in the number of nearest neighbors 504 can be selected. User signals can be embedded into the embedding space during on device content retrieval (for example, asynchronous to the ad retrieval call, during the ad retrieval call). In some implementations, the user signal embedding can exists within a separate embedding space. A relationship can be established between user signal embeddings and digital component embeddings for models that have been optimized using dot product similarity. K nearest neighbor can select the top k nearest neighbors from a joint embedding space including both the digital component embedding space and the user signal embedding space. The nearest neighbors in the joint embedding space to the user signal embedding can be found. A similarity metric can be defined for the distance between the user signal embedding and the digital component embeddings in the joint embedding space. The similarity metric allows the closest digital component embedding to the user signal embedding to be found. In some implementations, the similarity metric can be determined using a dot product similarity that outputs a scalar value. For example, user_signals_embedding·digital_component_1_embedding=10. In some examples, user_signals_embedding-digital_component_2_embedding=20. The dot product similarly can output a higher scalar value the more similar the embeddings. For example, when K=1 to select the closest neighbor, the digital_component_2 can be selected as the dot product similarity between the user signal embedding and the digital component embedding 2 resulted in the highest similarity score of 20.

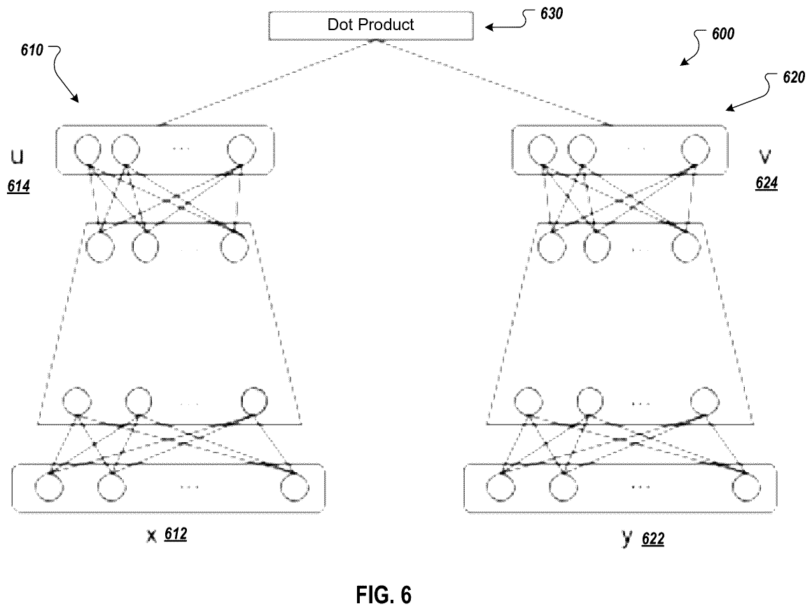

FIG. 6 is a diagram of an example environment 600 including a two tower model. The environment 600 includes a first model 610 and a second model 620. The first model 610 and the second model 620 can be trained to select digital components with which users are more likely to interact. The training data can include digital components that are displayed to users and user interactions (for example, clicks) with the digital components. The first model 610 can receive query 612 as an input and output embedding 614. The second model 620 can receive query 622 as an input and output embedding 624. The embeddings 614 and 624 can be determined using a transformation applied to input signals (for example, user signals, digital component signals) into a model interpretable embedding space. For example, embedding 614 can correspond to digital component signals and embedding 624 can correspond to query signals (for example, user signals, contextual signals). The first model 610 can encode digital component features into an embedding, and the second model 620 can encode query (user+contextual) features into an embedding. One digital component can produce one digital component embedding, and one query can produce one query embedding.

The embeddings 614 and 624 can be used to calculate a dot product 630. The dot product can be calculated as the embedding 614*the embedding 624 to produce a scalar value that represents the similarity between the two embeddings. During serving or inference, the dot product between the embeddings can be used to product a similarly score. The higher the similarity score, the better a candidate digital component matches the query. The dot product 630 can be used to select digital components to send to applications. The inputs can include contextual data, first party user behavior data, and noised aggregate user behavior data.

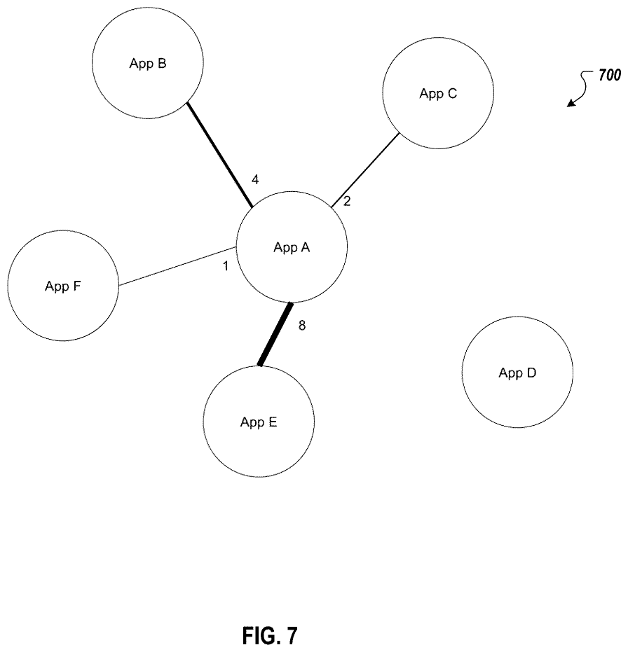

FIG. 7 is a diagram of an example environment 700 illustrating relationships between applications. The environment 700 includes applications A-F. Historical data on aggregate app usage behaviors can be used as inputs for a model to select digital components. The historical data can include aggregate cross app information. For example, the historical data can include an indication that users generally visit applications B and C in that same week as the users visit application A. The historical data can be presented as a graph where the nodes are the applications and the edges are the historical frequency that users, on aggregate, visit both a first application and another application on a single device over some time period. The edge between application A and application B can include a value of 4 representing a frequency that users accessed application A and also accessed application B. The edge between application A and application C can include a value of 2 representing a frequency that users accessed application A and also accessed application C. There may be no edge between application A and application D indicating that users do not access application A and application D within a time period. The edge between application A and application E can include a value of 8 representing a frequency that users accessed application A and also accessed application E. The edge between application A and application F can include a value of 1 representing a frequency that users accessed application A and also accessed application F.

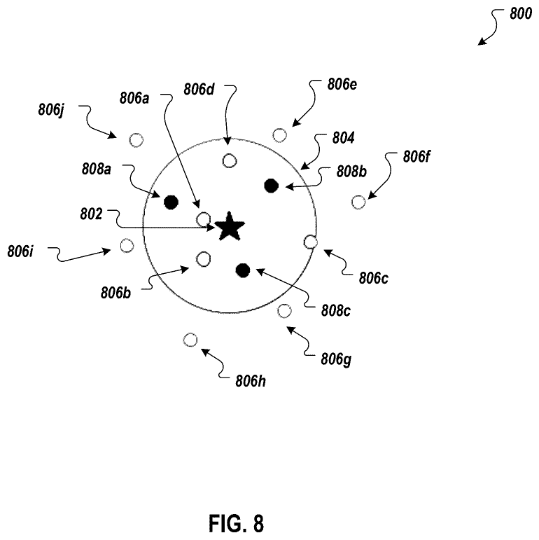

FIG. 8 is a diagram of an example embedding space 800. The embedding space 800 includes an average feature embedding 802, query feature embeddings 808a-c, a number of nearest neighbors 804, and candidate digital component embeddings 806a-j. The embedding space 800 can include data that was either accumulated using privacy safe aggregate reporting or from voluntary panel data contributions where users opt in and let a DSP collect the data. The average feature embedding 802 can represent that for a given first party app (app 1) that it is currently making a digital component request, app 2 and app 3 are generally also used by users who use app 1 (for example, on aggregate behavior). This information can be obtained from users who voluntarily contribute third party data using panel data collection and/or from aggregate reporting. The average feature embedding 802 can include the average of all the different query embeddings for each of the apps. The average feature embedding 802 can be used when digital component requests only include first party data so that certain third party information can be used to help tailor better digital components sent down to the device through aggregate reporting and/or panel based data collection. The top number of closest nodes can be selected and signals about those applications can be fed into the two tower model for better digital component retrieval. This same approach can be used for application similarity.

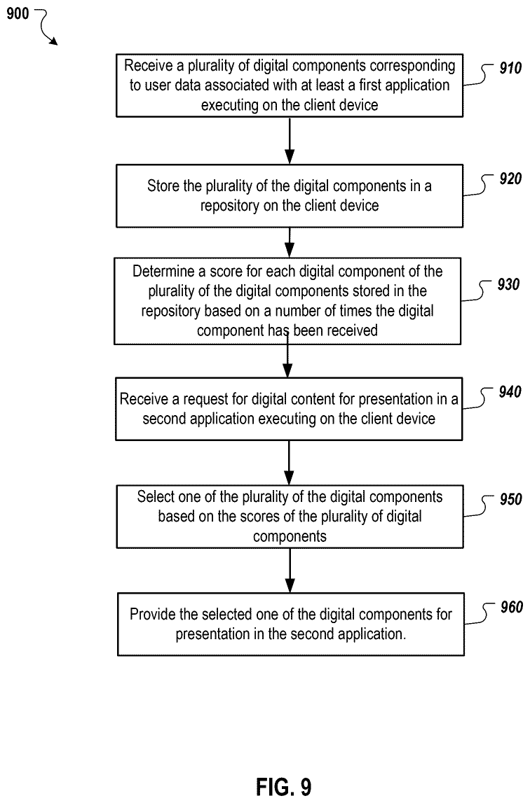

FIG. 9 is a flow diagram of an example process 900 for providing a digital component for display at a client device in a privacy preserving manner. Operations of the process 900 can be performed by a trusted server, e.g., the client device 110 of FIG. 1. Operations of the process 900 can also be implemented as instructions stored on one or more computer readable media, which may be non-transitory, and execution of the instructions by one or more data processing apparatus can cause the one or more data processing apparatus to perform the operations of the process 900.

A computing device receives, from one or more content platforms, a plurality of digital components. Each of the digital components corresponds to user data associated with at least a first application executing on the client device (910). The plurality of the digital components can be received in response to a request from the first application. The user data associated with at least the first application can include at least one of first party data, contextual data, or privacy safe data. The user data associated with at least the first application can include a sequence of actions which a user performed with the second application.

A computing device stores the plurality of the digital components in a repository on the client device (920). The repository can store digital components received from content platforms in response to requests from a plurality of applications executing on the client device. For example, a second plurality of the digital components can be received in response to a request from a third application on the client device.

A computing device determines a score for each digital component of the plurality of the digital components stored in the repository based on a number of times the digital component has been received (930). The score can be determined by scoring a first digital component included in both the first subset of the plurality of the digital components and the second subset of the plurality of the digital components higher than a second digital component not include in both the first subset of the plurality of the digital components and the second subset of the plurality of the digital components.

A computing device receives a request for digital content for presentation in a second application executing on the client device (940). The second application is different than the first application. The request for digital content for presentation in a second application can include the user data.

A computing device selects one of the plurality of the digital components based on the scores of the plurality of digital components (950). The digital components can be selected based on the user data.

A computing device provides the selected one of the digital components for presentation in the second application (960).

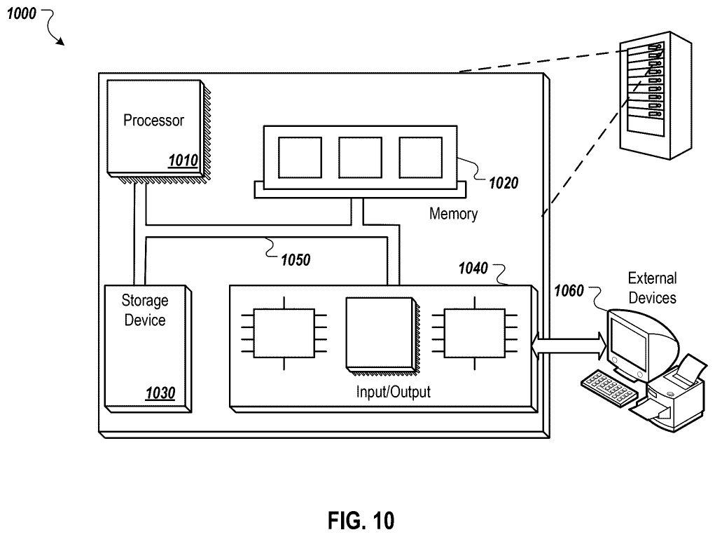

FIG. 10 is a block diagram of an example computer system 1000 that can be used to perform operations described above. The system 1000 includes a processor 1010, a memory 1020, a storage device 1030, and an input/output device 1040. Each of the components 1010, 1020, 1030, and 1040 can be interconnected, for example, using a system bus 1050. The processor 1010 is capable of processing instructions for execution within the system 1000. In some implementations, the processor 1010 is a single-threaded processor. In another implementation, the processor 1010 is a multi-threaded processor. The processor 1010 is capable of processing instructions stored in the memory 1020 or on the storage device 1030.

The memory 1020 stores information within the system 1000. In one implementation, the memory 1020 is a computer-readable medium. In some implementations, the memory 1020 is a volatile memory unit. In another implementation, the memory 1020 is a non-volatile memory unit.

The storage device 1030 is capable of providing mass storage for the system 1000. In some implementations, the storage device 1030 is a computer-readable medium. In various different implementations, the storage device 1030 can include, for example, a hard disk device, an optical disk device, a storage device that is shared over a network by multiple computing devices (e.g., a cloud storage device), or some other large capacity storage device.

In some embodiments, one or more elements of the client device 110 (e.g., application 112, signals 114, signals 116, digital component repository 118), one or more elements of the client device 210 (e.g., applications 212a and 212b, selection engine 214, digital component repository 218), one or more elements of the client device 310 (e.g., applications 312a and 312b, selection engine 314, digital component repository 318), and/or one or more elements of the client device 410 (e.g., applications 412a-412c, selection engine 414, digital component repository 418) can be included in at least one memory 1020 and/or at least one storage device 1030.

The input/output device 1040 provides input/output operations for the system 1000. In some implementations, the input/output device 1040 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 1060, e.g., keyboard, printer and display devices. Other implementations, however, can also be used, such as mobile computing devices, mobile communication devices, set-top box television client devices, etc.

Although an example processing system has been described in FIG. 10, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a client device and from one or more content platforms, a plurality of digital components, wherein each of the digital components corresponds to user data associated with at least a first application executing on the client device;
storing, by the client device, the plurality of the digital components in a repository on the client device;
determining, by the client device, a score for each digital component of the plurality of the digital components stored in the repository, wherein the determining is based on a number of times the digital component has been received;
receiving, by the client device, a request for digital content for presentation in a second application executing on the client device, wherein the second application is different than the first application;
selecting, by the client device, one of the plurality of the digital components based on the scores of the plurality of digital components; and
providing, by the client device, the selected one of the digital components for presentation in the second application.

2. The computer-implemented method of claim 1, wherein the plurality of the digital components are received in response to a request from the first application, and the method further comprises:
receiving a second plurality of the digital components in response to a request from a third application on the client device.

3. The computer-implemented method of claim 2, wherein scoring each digital component of the plurality of the digital components stored in the repository comprises scoring a first digital component included in both the first subset of the plurality of the digital components and the second subset of the plurality of the digital components higher than a second digital component not include in both the first subset of the plurality of the digital components and the second subset of the plurality of the digital components.

4. The computer-implemented method of claim 1, further comprising:
determining that a number of digital components in the repository on the client device exceeds a predetermined threshold value; and
in response to determining that the number of digital components in the repository on the client device exceeds the predetermined threshold value, removing a digital component with a lowest score from the repository on the client device.

5. The computer-implemented method of claim 1, wherein the user data associated with at least the first application comprises at least one of first party data, contextual data, or privacy safe data.

6. The computer-implemented method of claim 1, wherein the user data associated with at least the first application comprises a sequence of actions which a user performed with the second application.

7. The computer-implemented method of claim 1, wherein the plurality of the digital components are received in response to transmitting a request that includes the user data associated with at least the first application.

8. The computer-implemented method of claim 1, wherein:
the request for the digital content for presentation in the second application comprises the user data; and
the one of the plurality of the digital components is selected based on the user data.

9. The computer-implemented method of claim 1, further comprising:
determining a second score for each digital component of the plurality of the digital components stored in the repository, wherein the second score is determined based on at least one of first party signals, third party signals, or contextual signals; and
selecting the one of the plurality of the digital components based on the scores and second scores of the plurality of digital components.

10. A computer-implemented method comprising:
receiving, by a server and from a client device, a request for digital components for presentation by the client device, wherein the request for the digital components include user data associated with at least a first application executing on the client device; and
in response to receiving the request for the digital component, transmitting, by the multi-platform server and to the client device, a plurality of digital components, wherein each of the digital components corresponds to the user data.

11. A system comprising:
one or more processors; and
one or more storage devices storing instructions that, when executed by the one or more processors, cause the one or more processor to carry out the method of any preceding claim.

12. A computer readable medium carrying instructions that, when executed by one or more processors, cause the one or more processors to carry out the method of any one of claims 1 to 10.

13. A computer program product comprising instructions which, when executed by a computer, cause the computer to carry out the steps of the method of any of claims 1 to 10.
